(19) United States
(12) Patent Application Publication
(10) Pub. No.: US 2005/0084241 A1
(43) Pub. Date: Apr. 21, 2005

(54) Video recorder and video server system

(75) Inventors: Hiromichi Ishibashi, Osaka (JP); Yoshiaki Komma, Osaka (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Matsushita Electric Industrial Co., Ltd.

(21) Appl. No.: 10/968,775

(22) Filed: Oct. 19, 2004

(30) Foreign Application Priority Data
Oct. 20, 2003 (JP) 2003-358666

(51) Int. Cl. H04N 5/76; G06F 3/00; G06F 13/00

(52) U.S. Cl. 386/83; 725/58

(57) ABSTRACT

A video recorder, connectable to a network, includes: a reservation manager for managing recording reservation information of a TV program; a recording drive for writing audiovisual data of the TV program on a removable data storage medium; and a controller for controlling the reservation manager and the recording drive. If the recording drive is loaded with the data storage medium so as to be ready to write the audiovisual data of the TV program on the storage medium, the controller prohibits any other appliance from accessing the recording drive through the network.

### BACKGROUND OF THE INVENTION

1. Field of the Invention

The present invention relates to a video recorder including a recording drive for writing data on a removable storage medium and also relates to a video server system in which such video recorders are connected together through a network.

2. Description of the Related Art

Recently, videocassette recorders, which used to be dominating consumer audiovisual equipment, are gradually being replaced by optical disk recorders, which use a disk storage medium such as a recordable or rewritable DVD (which will be referred to herein as an “optical disk”) to read and write audiovisual data therefrom/thereon by an optical technique. The optical disk has a planar data storage layer on which digital audiovisual data is stored. In performing a read or write operation on such an optical disk, an optical head can access any arbitrary location on the data storage layer in a matter of seconds. Accordingly, even if multiple titles of video data are stored on the same optical disk, any of those titles can be played back in a short time. Also, the optical disk as a storage medium is removable and exchangeable, and there is no storage capacity limit on the optical disk recorder itself. By making use of these advantageous features of the optical disk, various new technologies have been proposed.

For example, Japanese Laid-Open Publication No. 11-260043 proposes the technique of storing program recording reservation information on an optical disk. If the program recording reservation information is stored on a given optical disk, then an optical disk recorder reads that information and makes a timer reservation such that its built-in TV tuner and optical disk drive start recording the designated program at a preset time.

Even if the optical disk, from which the reservation information has been read, is removed from the optical disk recorder after the reservation has been done, that reservation information remains on that optical disk. Accordingly, if that optical disk is loaded into another optical disk recorder, that optical disk recorder can also read the reservation information from the optical disk and can make a reservation of a program to be stored on the optical disk in accordance with the reservation information. According to this technique, a program to be recorded is reserved in accordance with the information stored on a given optical disk, and there is no need to make a reservation of the same program all over again even if the optical disk is loaded into another optical disk recorder.

Meanwhile, optical disks have also been used as computer data storage media, not just as audiovisual data storage media, and contribute immensely to allowing the user to exchange data with a computer system easily. Thus, Japanese Laid-Open Publication No. 12-90575 proposes that a number of optical disk recorders be used as a so-called “distributed server” by using optical disks as removable high-capacity storage media and by connecting the optical disk recorders with those disks together through a network. Furthermore, Japanese Laid-Open Publication No. 13-268461 discloses a system, which is specially designed to record multiple telecasts on different channels simultaneously by using the tuner of another appliance included on the same network. In a distributed server like this, however, the greater the number of recorders connected, the more and more often the same recorder or tuner gets accessed simultaneously, thus causing a so-called “traffic problem” as in a computer network. Japanese Laid-Open Publication No. 14-077745 proposes a method for overcoming such a problem.

In a computer network, hard disk drives are used as data storage media. A hard disk drive usually has a big storage capacity but is non-removable in many cases. Thus, the data stored in the hard disk drive of any computer can be managed by any other computer linked to the same network.

In a video server system composed of optical disk recorders on the other hand, optical disks used as storage media are removable, and therefore, one of those optical disks could be ejected suddenly and unintentionally by another user of the same network. More specifically, suppose a first user has left a recordable or rewritable optical disk loaded in an optical disk recorder to be managed by himself or herself. In that case, a second user might make a program reservation through the network such that his or her desired program will be stored on the optical disk left in that optical disk recorder of the first user's. Even so, if the first user removed the optical disk from his or her optical disk recorder, then the reserved recording designated by the second user would not be carried out by the optical disk recorder of the first user's. However, that optical disk recorder could be not only unable to fulfill the reserved recording but also fall into a totally inoperative state, too. If that happened, no anticipated response could be received from the optical disk recorder in question, no matter how many times another user has attempted to access that recorder, thus possibly causing a network failure.

### SUMMARY OF THE INVENTION

In order to overcome the problems described above, preferred embodiments of the present invention provide a video recorder and video server system that allows the user to make a reservation of a TV program through a network while maintaining the advantages of using removable data storage media.

A video recorder according to a preferred embodiment of the present invention is connectible to a network. The recorder preferably includes: a reservation manager for managing recording reservation information of a TV program; a recording drive for writing audiovisual data of the TV program on a removable data storage medium; and a controller for controlling the reservation manager and the recording drive. If the recording drive is loaded with the data storage medium so as to be ready to write the audiovisual data of the TV program on the storage medium, the controller preferably prohibits any other appliance from accessing the recording drive through the network.

In one preferred embodiment of the present invention, the reservation manager preferably sends out a reservation inquiry on the recording reservation information to at least one TV receiver connected to the network, receives an answer from the TV receiver regarding whether or not the TV program is receivable, defines receiver reservation setting information about the TV program to be received by the TV receiver, and transmits the receiver reservation setting information to the TV receiver.

In this particular preferred embodiment, the recording reservation information has preferably been stored on the data storage medium, and the recording drive preferably reads the reservation information from the storage medium and passes the reservation information to the reservation manager.

In another preferred embodiment, the data storage medium is preferably an optical disk.

A video server system according to a preferred embodiment of the present invention preferably includes: at least one server on a first end, the server including a tuner for receiving TV programs and a reservation manager for allowing a user to make a reservation of a TV program to receive; and a server on a second end, including the video recorder according to the preferred embodiment described above, which is connected to the server on the first end through a network.

In one preferred embodiment of the present invention, the server on the first end preferably further includes a compressor for compressing audiovisual data of the TV program received. In that case, if a recording rate of the TV program, included in the receiver reservation setting information transmitted by the server on the second end, is lower than a transfer rate of the TV program that has been received by the tuner of the server on the first end, then the server on the first end preferably compresses the audiovisual data of the TV program received and then transmits the data through the network such that an image quality rate of the TV program becomes equal to that defined by the receiver reservation setting information.

In this particular preferred embodiment, the server on the first end preferably further includes: a storage drive for storing the TV program that has been received by the tuner; and an encryptor for making a cryptographic key and encrypting the audiovisual data of the received TV program with the cryptographic key. In that case, if the recording rate of the TV program, included in the receiver reservation setting information transmitted by the server on the second end, is lower than the transfer rate of the TV program that has been received by the tuner of the server on the first end, then the server on the first end preferably encrypts the audiovisual data of the TV program with the cryptographic key, stores the encrypted audiovisual data of the TV program on the storage drive, and transmits the cryptographic key to the server on the second end over the network such that the cryptographic key, as well as the compressed data, is stored on the data storage medium.

More specifically, the server on the first end preferably further includes a timer for keeping time. When the timer tells that a predetermined amount of time has passed since the encrypted audiovisual data of the received TV program was stored on the storage drive, the server on the first end preferably deletes the encrypted audiovisual data of the TV program from the storage drive.

According to various preferred embodiments of the present invention described above, while a video recorder is ready to fulfill a program recording reservation, no other appliance connected to the same network is allowed to access that video recorder. Accordingly, even if the storage medium were removed from that video recorder, no other appliance could even attempt to access the removed storage medium, and therefore, no network failure should arise. Consequently, proper network connection can be maintained while the removability of storage media still taken advantage of.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram showing a video server system according to a first specific preferred embodiment of the present invention.

FIGS. 2A, 2B and 2C show various pieces of information for use to make a recording reservation of a TV program received.

FIG. 3 schematically illustrates how access to the recording drive of the server on the second end is prohibited.

FIG. 4 is a block diagram showing another video server system according to the first preferred embodiment.

FIG. 5 is a block diagram showing a video server system according to a second specific preferred embodiment of the present invention.

### DETAILED DESCRIPTION OF PREFERRED EMBODIMENTS

Embodiment 1

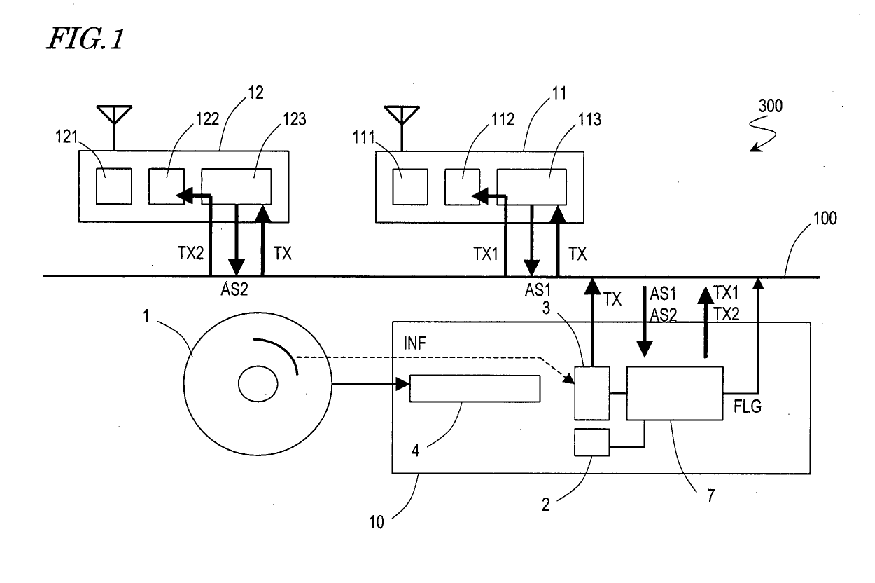

FIG. 1 is a block diagram showing a configuration for a video server system 300 according to a first specific preferred embodiment of the present invention. The video server system 300 preferably includes three servers 10, 11 and 12, which may be grouped into the servers 11 and 12 on the first end and the server 10 on the second end according to their respective functions. Each of these three servers 10, 11 and 12 preferably includes an interface connectible to a network 100 such that data can be transmitted and received from one end to the other. In this preferred embodiment, the video server system 300 includes two servers 11 and 12 on the first end. However, at least one server needs to be provided on the first end.

Each of the servers 11 and 12 on the first end preferably functions as a TV receiver for receiving TV programs. The server 11 preferably includes a tuner 111, a timer 112 and a reservation manager 113. The tuner 111 selectively receives a TV program on a selected channel. In this preferred embodiment, the tuner 111 cannot receive two or more TV programs at the same time. The timer 112 keeps time. The reservation manager 113 instructs the tuner 111 what TV program on which channel should be received when. A TV program to receive is determined by its broadcaster's channel number and its scheduled showing date and time. Thus, the reservation manager 113 may be regarded as managing TV programs to receive. The information such as the channel number and the scheduled date and time of a TV program to receive and reserve will be referred to herein as “receiver reservation setting information”. And the reservation manager 113 stores this receiver reservation setting information. With reference to the time clocked by the timer 112, the reservation manager 113 instructs the tuner 111 to receive the designated TV program on the selected channel at the time specified by the receiver reservation setting information. The receiver reservation setting information may be input either by a personal computer provided for the server 11 or by any other appliance connected to the same network 100.

The reservation manager 113 also receives a reservation inquiry from another appliance (e.g., the server 10 on the second end in this preferred embodiment) through the network 100. The reservation inquiry includes information about the TV program to be transmitted to that another appliance (i.e., the information about the broadcaster's channel number and scheduled showing date and time) over the network 100. On receiving the reservation inquiry, the reservation manager 113 makes reference to the receiver reservation setting information stored there to return an answer indicating whether or not no reservation has been made yet (i.e., whether or not the tuner 111 is available) at the date and time specified by the reservation inquiry.

Just like the server 11, the other server 12 on the first end also includes a tuner 121, a timer 122 and a reservation manager 123, each of which has the same function as the counterpart of the server 11 described above. The respective tuners 111 and 112 of the servers 11 and 12 may receive TV programs compliant with the same standard or mutually different standards. Also, if a TV program is controlled so as to be viewable and audible to only subscribed users that have a contract with, or have registered with, a broadcaster, then the tuners 111 and 121 may have the function of disabling the viewing control based when the user is under such a contract or registration. In this preferred embodiment, the tuners 111 and 112 are supposed to receive TV programs compliant with the same standard, more specifically, standard definition (SD) compliant TV programs.

The server 10 on the second end preferably includes a recording drive 4, a timer 2, a reservation manager 3 and a controller 7 so as to function as a video recorder including a recording drive.

The recording drive 4 is loaded with a removable storage medium 1 to write and store data on the storage medium 1. The recording drive 4 may be an optical disk drive to use an optical disk, a memory drive to use a nonvolatile memory, or a removable hard disk drive with a relatively small storage capacity. In this preferred embodiment, an optical disk drive that uses an optical disk as the storage medium 1 is adopted as the recording drive 4.

The timer 2 keeps time. The reservation manager 3 stores and manages the recording reservation information of a TV program to be recorded by the recording drive 4. In this preferred embodiment, the recording reservation information INF to be stored on the reservation manager 3 has already been stored on the storage medium 1. However, the recording reservation information INF may also be acquired either via the Internet or through an EPG available for telecasts. Alternatively, the recording reservation information INF may also be directly input by the user with a remote controller, for example. As another alternative, the recording reservation information INF may be input with a personal computer. Specific items of the recording reservation information INF include the broadcaster's channel number, recording start time, recording end time, and bit rate defining the resultant image quality (which will be referred to herein as “recording rate”). As used herein, the “recording rate” does not refer to the transfer rate of the program that was set by the broadcaster but to a rate that reflects the user's preference on the image definition of the program to store. The recording rate is also changeable depending on whether or not the recording drive 4 or the storage medium 1 can handle a write operation at the recording rate and how much storage capacity is still available on the storage medium 1.

Also, to see if there will be a TV receiver available on the network 100 at the date and time and broadcaster's channel specified by the recording reservation information INF, the reservation manager 3 sends out a reservation inquiry TX through the network 100. On receiving an answer from the available TV receiver connected to the network 100, the reservation manager 3 transmits the receiver reservation setting information to that TV receiver based on the answer.

The controller 7 not only functions as an interface in transferring data but also controls the recording drive 4, timer 2 and reservation manager 3 as well. Also, if the recording drive 4 is loaded with the data storage medium 1 and has already accepted a recording reservation, then the controller 7 prohibits any other appliance from accessing the recording drive 4 through the network 100.

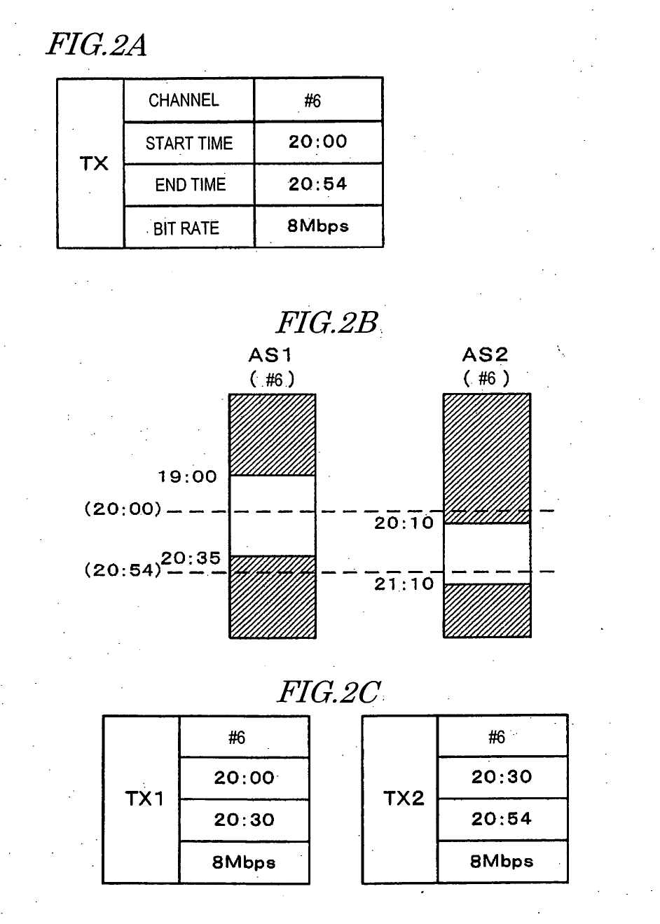

Hereinafter, it will be described how the video server system 300 operates. First, a storage medium 1, on which recording reservation information INF has been stored, is loaded into the recording drive 4 of the server 10 on the second end. Once the recording drive 4 has been loaded with the storage medium 1, the recording reservation information INF is read out from the storage medium 1 and passed to the reservation manager 3. In response, the reservation manager 3 makes a reservation inquiry TX based on the recording reservation information INF and sends out the inquiry TX over the network 100. FIG. 2A shows an exemplary reservation inquiry TX, which includes a broadcaster's channel number of #6, a recording start time of 20:00, a recording end time of 20:54 and a recording rate of 8 Mbps. No dates are shown in FIG. 2A for the sake of simplicity. However, each of the recording start and end times actually includes a specified date. In this preferred embodiment, the recording rate specified by the reservation inquiry TX is supposed to be equal to the transfer rate of the TV programs to be received by the servers 11 and 12 on the first end.

The reservation inquiry that has been sent out over the network 100 is received by the servers 11 and 12 on the first end. The respective reservation managers 113 and 123 of the servers 11 and 12 on the first end make reference to their own receiver reservation setting information and returns answers AS1 and AS2 to the server 10 on the second end through the network 100 to tell the server 10 whether or not their tuners 111 and 121 will be available at the dates specified by the reservation inquiry TX. FIG. 2B schematically illustrate exemplary answers AS1 and AS2. More specifically, the answer AS1 shows that the tuner 111 of the server 11 on the first end will be available for use from 19:00 through 20:35 on the date specified by the reservation inquiry TX, while the answer AS2 shows that the tuner 121 of the server 12 on the first end will be available for use from 20:10 through 21:10 on the date specified by the reservation inquiry TX. In the other time slots, neither the tuner 111 of the server 11 nor the tuner 121 of the server 12 will be available.

The reservation manager 3 of the server 10 on the second end receives the answers AS1 and AS2, defines receiver reservation setting information TX1 and TX2 based on these answers AS1 and AS2 and then transmits the information TX1 and TX2 to the servers 11 and 12, respectively, over the network 100. As shown in FIG. 2C, the receiver reservation setting information TX1 may include information that will operate the server 11 on the first end so as to receive a TV program on Channel #6 from 20:00 through 20:30 and transmit the received audiovisual data of the program to the server 10 on the second end at a transfer rate of 8 Mbps. On the other hand, the receiver reservation setting information TX2 may include information that will operate the server 12 on the first end so as to receive the TV program on Channel #6 from 20:30 through 20:54 and transmit the received audiovisual data of the program to the server 10 on the second end at a transfer rate of 8 Mbps. By sending out these pieces TX1 and TX2 of receiver reservation setting information, the recording drive 4 can get ready to fulfill the recording reservation.

The receiver reservation setting information may be defined based on the answers and following any of various rules. For example, if multiple servers are available at the date and time specified by the reservation inquiry TX, then the receiver reservation setting information may be defined so as to use as small a number of servers as possible. This is because the smaller the number of servers to use, the smaller the number of servers occupied. Conversely, even in the situation where multiple servers are available at the date and time specified by the reservation inquiry TX, the receiver reservation setting information may be defined so as to use as large a number of servers as possible. In that case, since a lot of servers are used, not only the load on the servers but also the network traffic can be dispersed.

When the reservation manager 3 has made a recording reservation after the recording drive 4 was loaded with the data storage medium 1, the controller 7 will no longer allow any other appliance connected to the network 100 to access the recording drive 4. For Example, a property of the recording drive 4 to be accessed may be automatically set as “playback only”. More specifically, as shown in FIG. 1, the controller 7 may raise a flag indicating that any access to the recording drive 4 is now prohibited, by changing a predetermined flag-bit allocated in a ID header of the recording drive 4.

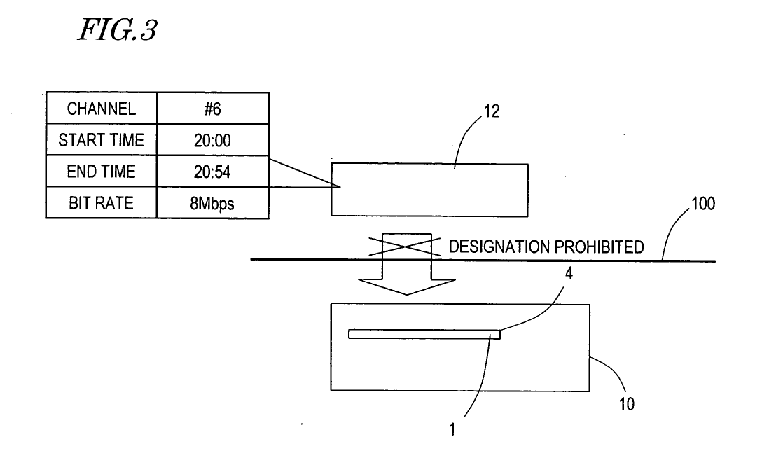

As a result, even if the user has made a receiver reservation using the server 12 on the first end and has specified the storage location of the received TV program using the same server 12 (i.e., has made a so-called “tuner-end reservation”), the user cannot specify the recording drive 4 of the server 10 on the second end as his or her desired storage location as shown in FIG. 3. Thus, it is possible to prevent a third party from recording an unwanted program on the storage medium 1. Also, even if the storage medium 1 were removed, no other appliance could even attempt to access the recording drive 4 of the server 10 on the second end, and therefore, no failure should arise in the network 100.

Alternatively, the access to the recording drive 4 may be prohibited by reserving the recording drive 4 or the whole server 10 as a region which is allowed to access by an administrator.

It should be noted that the user of the server 10 on the second end may remove the optical disk 1 from the server 10 at any time. However, this removal of the optical disk 1 is done by the user on purpose. Accordingly, the network is not shut down abruptly but the user has just canceled his or her reservation intentionally. Unlike a network of personal computers, an AV network such as a video server system tends to have fixed users with servers (e.g., video recorders) that are connected to the network. This is why it should be rare to see the storage medium 1 ejected unintentionally from the server 10 on the second end by another user.

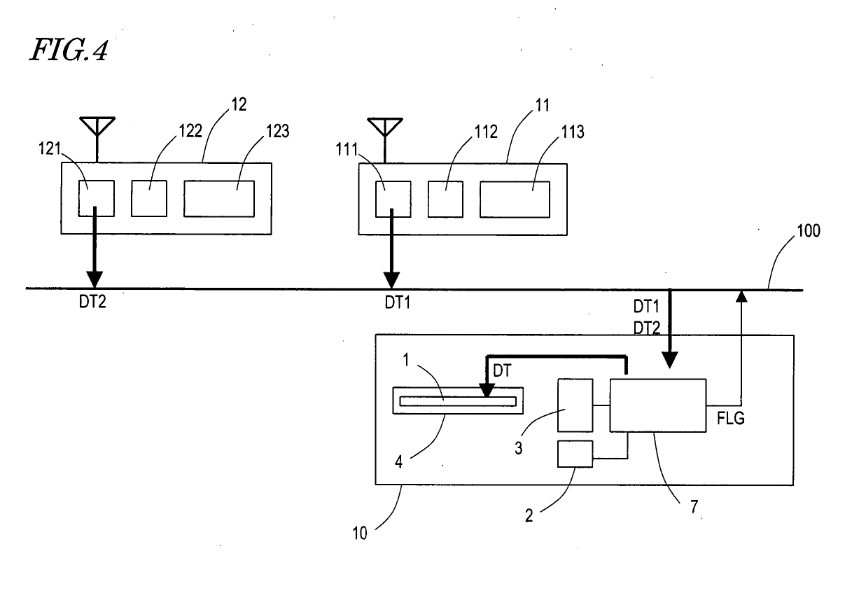

As shown in FIG. 4, when it's the scheduled recording start time of 20:00, the tuner 111 of the server 11 on the first end starts receiving the TV program on Channel #6 in accordance with the receiver reservation setting information TX1 stored on the reservation manager 113, and transmits program data DT1 to the server 10 on the second end over the network 100. In the server 10 on the second end, the recording drive 4 writes the program data DT1 in accordance with the recording reservation information stored on the reservation manager 3. Thereafter, when it's the scheduled recording end time specified by the receiver reservation setting information TX1, the tuner 111 of the server 11 on the first end stops receiving the TV program on Channel #6. Subsequently, in accordance with the receiver reservation setting information TX2 stored on the reservation manager 123, the tuner 121 of the server 12 on the first end starts receiving the rest of the TV program on Channel #6, and transmits program data DT2 to the server 10 on the second end over the network 100. In the server 10 on the second end, the recording drive 4 continues to write the program data DT2 received. The program data DT1 and DT2 are eventually combined together and stored as program data DT on the storage medium 1 in the recording drive 4. When the recording operation is finished, the recording reservation information INF, which has been stored on the reservation manager 3 of the server 10 on the second end, is deleted. As a result, the controller 7 no longer prohibits access to the recording drive 4.

As described above, according to this preferred embodiment, a video recorder, which includes a recording drive for writing data on a removable storage medium and is connected to a network, can record a TV program being received by a TV receiver that is also connected to the same network. Also, while the video recorder is waiting to fulfill a recording reservation, no other appliance connected to the network can access the video recorder. Accordingly, if the storage medium has been removed from the video recorder, no other appliance can even attempt to access that storage medium, which would otherwise cause a serious network failure. Thus, proper network connection can be maintained while the removability of storage media still taken advantage of.

In the preferred embodiment described above, the server 10 on the second end includes no tuners. However, the server 10 may include a tuner. In that case, if the tuner of the server 10 on the second end satisfies the conditions specified by the recording reservation information, the server 10 can record any desired TV program by using its own tuner. Even so, network failures can also be eliminated by prohibiting any other appliance from accessing the server 10.

Embodiment 2

In the first preferred embodiment described above, the rate at which the user records his or her desired TV program with the recording drive 4 (i.e., the recording rate) is supposed to be equal to the transfer rate of that program. However, a video server system according to this second specific preferred embodiment can record a TV program with a recording drive at a bit rate, which is lower than the transfer rate of the TV program received, but the user can still view that program at the original transfer rate. For example, if a TV program is broadcast so as to comply with the high definition (HD) standard but the recording drive 4 is compliant with only the SD standard, not the HD standard, or if the recording drive 4 complies with the HD standard but the user wants to record a TV program at a bit rate that is lower than that defined by the HD standard for the purpose of long hour recording, for instance, this preferred embodiment can be used particularly effectively.

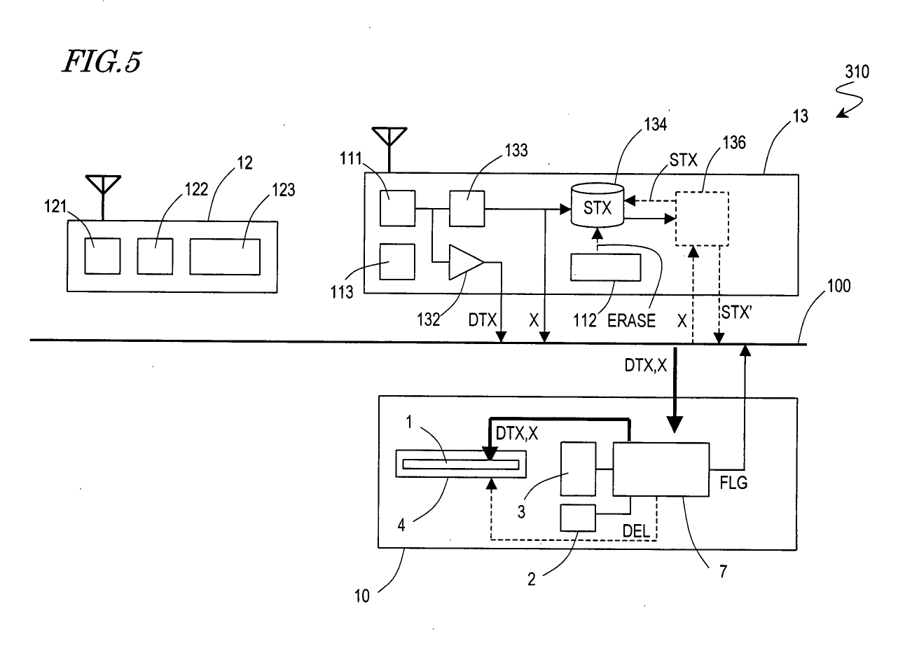

FIG. 5 is a block diagram showing a configuration for a video server system 310 according to a second specific preferred embodiment of the present invention. The video server system 310 preferably includes a server 13 on the first end and a server 10 on the second end, which are connected together through a network 100. Another server 12 on the first end is also shown in FIG. 5 but is not used in this preferred embodiment.

The server 13 on the first end preferably includes a tuner 111, a timer 112, a reservation manager 113, a compressor 132, an encryptor 133, and a storage drive 134. In this preferred embodiment, the tuner 111 preferably receives an HD-compliant TV program. The timer 112 and reservation manager 113 function just like the counterparts of the first preferred embodiment described above.

The compressor 132 compresses the audiovisual data of the TV program that has been received by the tuner 111 so as to have a recording rate as specified by the receiver reservation setting information TX1 stored in the reservation manager 113. In this preferred embodiment, the compressor 132 down-converts the HD compliant program data into SD compliant program data by a re-encoding method. More specifically, first, the compressor 132 decodes the received HD-compliant program data into decompressed data. Next, the compressor 132 encodes this decoded data again at a higher compression rate, thereby converting it into SD compliant data. Alternatively, the compressor 132 may convert the data by any other method or algorithm as long as the compressor 132 can cut down the size of the data. For example, the compressor 132 may transcode the program data at a lower bit rate although the standard with which the received program complies is just as defined by the receiver reservation setting information.

The encryptor 133 makes a predetermined cryptographic key X and transmits it to the server 10 on the second end through the network 100. Also, the encryptor 133 receives the program data from the tuner 111, encrypts the program data with the cryptographic key X and then passes the encrypted data to the storage drive 134. In this case, the “cryptographic key X” does not refer to a key that has already been added by a broadcaster or a content provider (e.g., content protection for recordable media (CPRM)). As will be described later, the cryptographic key X is defined and used only between the servers 13 and 10 on the first and second ends. The cryptographic key X may be made by various methods. For example, the encryptor 133 may generate random numbers and use them as the cryptographic key X. Alternatively, the cryptographic key X may also be produced based on date, time, or any other suitable information. As another alternative, the first several bits of the received TV program data may be used as the cryptographic key X. Also, the encryptor 133 may encrypt the data by scrambling it using an appropriate cryptographic key X as a basis. Furthermore, the encryption may also be done so as to comply with either the data encryption standard (DES) or advanced encryption standard (AES).

The storage drive 134 is preferably a storage device with a big storage capacity such as a hard disk drive.

The server 13 on the first end preferably further includes a decoder 136 for decoding the encrypted data with the cryptographic key X.

Hereinafter, it will be described how the video server system 310 operates. The video server system 310 of this second preferred embodiment allows the user to make a TV program recording reservation just as already described for the first preferred embodiment. When it's scheduled recording start time, the tuner 111 of the server 13 on the first end starts receiving the TV program in accordance with the receiver reservation setting information. The transfer rate of the TV program received at the tuner 111 is higher than that specified by the receiver reservation setting information. Accordingly, the audiovisual data of the TV program is not directly output to the network 100 but is passed to the compressor 132 before that. In response, the compressor 132 compresses the audiovisual data of the received TV program such that the image quality rate of the data is equal to that specified by the receiver reservation setting information. As a result, the compressed audiovisual data DTX of the received TV program is transmitted to the server 10 on the second end through the network 100.

The encryptor 133 makes a predetermined cryptographic key X and transmits it to the server 10 on the second end through the network 100. Also, the encryptor 133 receives the non-compressed program data from the tuner 111, encrypts the program data with the cryptographic key X and then passes the encrypted data to the storage drive 134. The storage drive 134 stores the encrypted program data STX thereon.

The server 10 on the second end stores the cryptographic key X and the compressed TV program data DTX on the storage medium 1, thereby completing the reserved recording operation. As shown in FIG. 5, the program data DTX has been stored on the storage medium 1 at a lower rate than the standard transfer rate of the program. On the storage drive 134 of the server 13 on the first end on the other hand, the encrypted program data STX has been stored at the same transfer rate as that of the received program (i.e., at a relatively high rate). However, the program data STX has been encrypted with the cryptographic key X that is stored only on the storage medium 1 in the server 10 on the second end. Accordingly, the program data STX stored in the server 13 on the first end is neither viewable nor audible. That is to say, in this video server system 310, it is only in the server 10 in the second end that the received program is recorded in a viewable and audible state.

As already described for the first preferred embodiment, the storage medium 1 is a removable medium. Accordingly, if the storage medium 1 on which the compressed program data DTX is stored is removed from the recording drive 4 and then loaded into another appliance, then the recorded compressed program data DTX can be played back elsewhere than the server 10 on the second end or with any other appliance that is not connected to the network 100.

If the user wants to view the recorded program at an image quality rate corresponding to the high bit rate of the program originally broadcast, then the controller 7 transmits the cryptographic key X from the server 10 on the second end to the server 13 on the first end through the network 100. Alternatively, the compressed program data DTX stored on the storage medium 1 may be transferred from another appliance, including a drive compatible with the storage medium 1, to the server 13 on the first end over the network 100. After having transmitted the cryptographic key X, the controller 7 issues an instruction DEL to delete the cryptographic key X and compressed program data DTX to the recording drive 4. In accordance with this instruction DEL, the cryptographic key X and compressed program data DTX are erased from the storage medium 1. Optionally, the cryptographic key X and compressed program data DTX may be invalidated, not erased, so as not to be readable from the storage medium 1.

In response, in the server 13 on the first end, the decoder 136 decodes the encrypted program data STX with the cryptographic key X received, thereby generating decoded program data STX′. Then, the decoded program data STX′ generated is transferred to the external appliance through the network 100 such that the user can view the decoded program data STX′. Alternatively, the decoded program data STX′ may also be stored on the storage drive 134. No matter whether the decoded program data STX′ is transferred through the network 100 or stored on the storage drive 134, the encrypted program data STX is erased once the decoded program data STX′ has been generated. In this manner, the decoded program data STX′ of the recorded program can be played back and viewed at an image quality rate corresponding to the high bit rate of the program originally broadcast. In this case, the compressed program data DTX that was stored on the storage medium 1 has already been erased, and therefore, the user cannot view the program by playing back the compressed program data DTX.

In such a video server system 310, the audiovisual data of a received TV program is never stored in two or more locations in a viewable state, i.e., is not supposed to be copied. Accordingly, the video server system 310 can contribute to appropriate copyright protection.

As described above, in this video server system 310, every time the TV program data is stored in the server 10 on the second end, the encrypted program data is stored and accumulated in the storage drive 134 of the server 13 on the first end, thus decreasing the available storage capacity of the storage drive 134 gradually. If this is a problem, then the video server system 310 may use the timer 112 such that the encrypted program data STX is deleted automatically when the timer 112 tells that a predetermined amount of time has passed since that data was saved. The amount of time allowed before the encrypted data STX is deleted is determined with various factors, including how often the user has accessed the data and how much capacity is left in the storage drive, taken into account. For example, if the user still has not decoded the encrypted data STX into the original data STX′ with the cryptographic key X even after several weeks have passed since the encrypted data STX was stored on the storage drive 134, then it seems that the user has already achieved his or her purpose by recording the program on the storage medium 1. In that case, the encrypted program data STX may be deleted when the timer 112 tells that it's about the time. In this manner, it is possible to prevent the storage drive 134 from decreasing its storage capacity excessively.

Various preferred embodiments of the present invention described above can be used effectively in various types of recorders that can write data on a removable storage medium such as an optical disk and that can be connected to a network. Also, those preferred embodiments are effectively applicable for use in a home AV server, to which such a recorder and a TV or radio tuner are connected, and in a server system including such a home AV server.

This application is based on Japanese Patent Applications No. 2003-358666 filed on Oct. 20, 2003 and No. 2004-299711 filed on Oct. 14, 2004, the entire contents of which are hereby incorporated by reference.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

1. A video recorder connectible to a network, the recorder comprising:
a reservation manager for managing recording reservation information of a TV program;
a recording drive for writing audiovisual data of the TV program on a removable data storage medium; and
a controller for controlling the reservation manager and the recording drive,
wherein if the recording drive is loaded with the data storage medium so as to be ready to write the audiovisual data of the TV program on the storage medium, the controller prohibits any other appliance from accessing the recording drive through the network.

2. The video recorder of claim 1, wherein the reservation manager sends out a reservation inquiry on the recording reservation information to at least one TV receiver connected to the network, receives an answer from the TV receiver regarding whether or not the TV program is receivable, defines receiver reservation setting information about the TV program to be received by the TV receiver, and transmits the receiver reservation setting information to the TV receiver.

3. The video recorder of claim 2, wherein the recording reservation information has been stored on the data storage medium, and
wherein the recording drive reads the reservation information from the storage medium and passes the reservation information to the reservation manager.

4. The video recorder of claim 1, wherein the data storage medium is an optical disk.

5. A video server system comprising:
at least one server on a first end, the server including a tuner for receiving TV programs and a reservation manager for allowing a user to make a reservation of a TV program to receive; and
a server on a second end, including the video recorder of claim 2 that is connected to the server on the first end through a network.

6. The video server system of claim 5, wherein the server on the first end further includes a compressor for compressing audiovisual data of the TV program received, and wherein if a recording rate of the TV program, included in the receiver reservation setting information transmitted by the server on the second end, is lower than a transfer rate of the TV program that has been received by the tuner of the server on the first end, then the server on the first end compresses the audiovisual data of the TV program received and then transmits the data through the network such that an image quality rate of the TV program becomes equal to that defined by the receiver reservation setting information.

7. The video server system of claim 6, wherein the server on the first end further includes:
a storage drive for storing the TV program that has been received by the tuner; and
an encryptor for making a cryptographic key and encrypting the audiovisual data of the received TV program with the cryptographic key, and
wherein if the recording rate of the TV program, included in the receiver reservation setting information transmitted by the server on the second end, is lower than the transfer rate of the TV program that has been received by the tuner of the server on the first end, then the server on the first end encrypts the audiovisual data of the TV program with the cryptographic key, stores the encrypted audiovisual data of the TV program on the storage drive, and transmits the cryptographic key to the server on the second end over the network such that the cryptographic key, as well as the compressed data, is stored on the data storage medium.

8. The video server system of claim 7, wherein the server on the first end further includes a timer for keeping time, and
wherein when the timer tells that a predetermined amount of time has passed since the encrypted audiovisual data of the received TV program was stored on the storage drive, the server on the first end deletes the encrypted audiovisual data of the TV program from the storage drive.
